(19) United States
(12) Patent Application Publication
(10) Pub. No.: US 2014/0337254 A1
(43) Pub. Date: Nov. 13, 2014

(54) RECOMMENDING ACTIONS FOR SOCIAL MEDIA ENGAGEMENTS

(71) Applicant: INTERNATIONAL BUSINESS MACHINES CORPORATION, Armonk, NY (US)

(72) Inventors: Jilin Chen, Mountain View, CA (US); Jeffrey W. Nichols, San Diego, CA (US)

(73) Assignee: International Business Machines Corporation, Armonk, NY (US)

(21) Appl. No.: 13/888,749

(22) Filed: May 7, 2013

(51) Int. Cl. G06N 99/00

(52) U.S. Cl. CPC G06N 99/005
USPC 706/12

(57) ABSTRACT

A recommendation of a direct engagements is made. A topic is received from a recommendee system, and a social media post is received from a social media server. A first and second information about the source of the social media post are determined. The first information can include the location of the source of the social media post, the readiness for engagement of the source of the social media post, or the personality of the source of the social media post. The second information can include the relevance of the content of the social media post to the topic, the opinion of the content of the social media post about the topic, or the intent of the content of the social media post regarding the topic. A direct engagement to be performed on the source based on the first information and the second information is determined.

### BACKGROUND

The present invention relates generally to social network analysis, and more particularly to recommending actions for social media engagements.

Social media platforms are well known. Recently, social media has been increasingly used for the direct engagement of the customers of businesses. For example, businesses directly engage their customers on social media for the purposes of direct marketing, viral marketing, opinion gathering, and customer support. The identification of customers (in this context, “targets”) for these engagements is often manual, such that a person has to decide what engagement action to take for each target on a case-by-case basis.

### SUMMARY

Embodiments of the present invention relate to making recommendations of direct engagements. In one embodiment, a topic is received from a recommendee system, and a social media post is received from a social media server. A first and second information about the source of the social media post are determined. The first information can include the location of the source of the social media post, the readiness for engagement of the source of the social media post, or the personality of the source of the social media post. The second information can include the relevance of the content of the social media post to the topic, the opinion of the content of the social media post about the topic, or the intent of the content of the social media post regarding the topic. A direct engagement to be performed on the source of the social media post based on the first information and the second information is determined.

### BRIEF DESCRIPTION OF THE SEVERAL VIEWS OF THE DRAWINGS

FIG. 1 is a block diagram of a recommender environment in accordance with an embodiment of the present invention.

FIG. 2 is a block diagram of the recommender environment of FIG. 1 depicting training interactions in accordance with an embodiment of the present invention.

FIG. 3 is a block diagram of the recommender environment of FIG. 1 depicting recommending interactions in accordance with an embodiment of the present invention.

FIGS. 4A and 4B are flowcharts depicting steps followed by a recommender system of the recommender environment of FIG. 1 during training interactions and recommending interactions in accordance with an embodiment of the present invention.

FIG. 5 is a block diagram of a computer system in accordance with an embodiment of the present invention.

### DETAILED DESCRIPTION

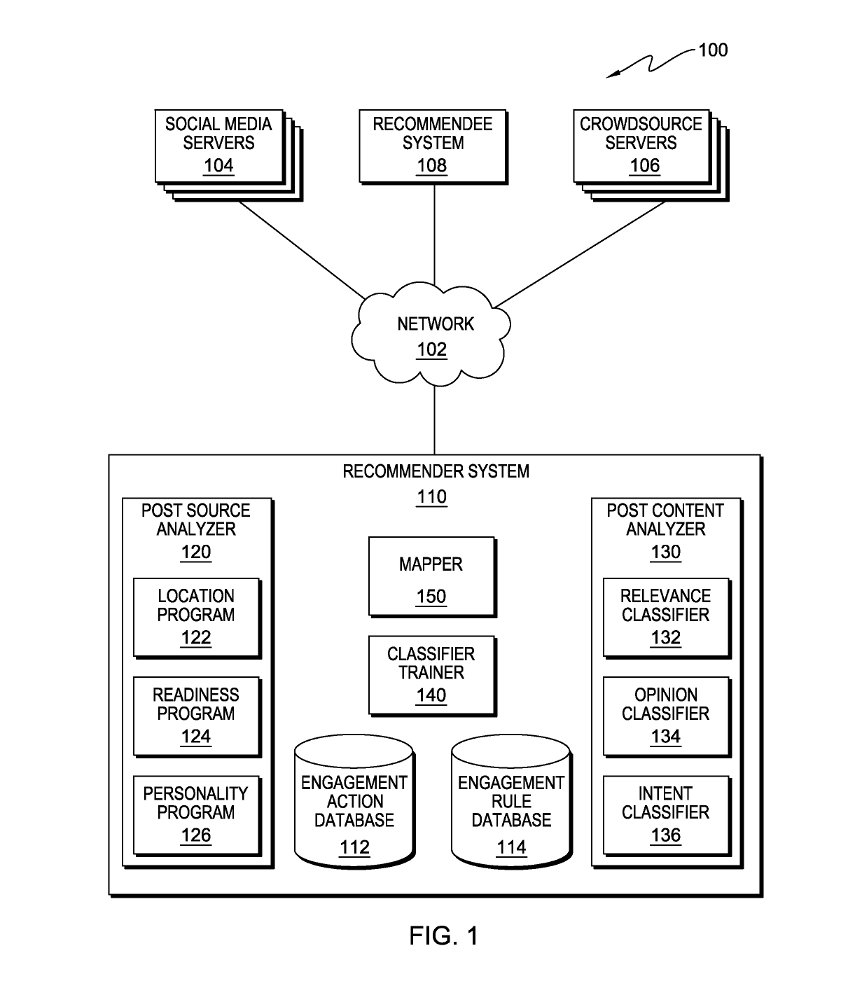

Referring now to FIG. 1, a block diagram of recommender environment 100 in accordance with an embodiment of the present invention is shown. Recommender environment 100 includes network 102, social media servers 104, crowdsource servers 106, recommendee system 108, and recommender system 110. Network 102 can be, for example, a local area network (LAN), a wide area network (WAN) such as the Internet, or a combination of the two, and can include wired or wireless connections. In general, network 102 can be any combination of connections and protocols that will support communications via various channels between social media servers 104, crowdsource servers 106, recommendee system 108, and recommender system 110 in accordance with an embodiment of the invention. As will be discussed in detail below, recommendee system 108 can prompt recommender system 110 to utilize social media servers 104 and crowdsource servers 106 during several training interactions to train one or more classifiers. Further, recommender system 110 can utilize social media servers 104 during several recommending interactions to recommend engagement actions to be performed by recommendee system 108 on the sources of social media posts of social media servers 104. Such recommended engagement actions can be performed for a large number of social media posts automatically.

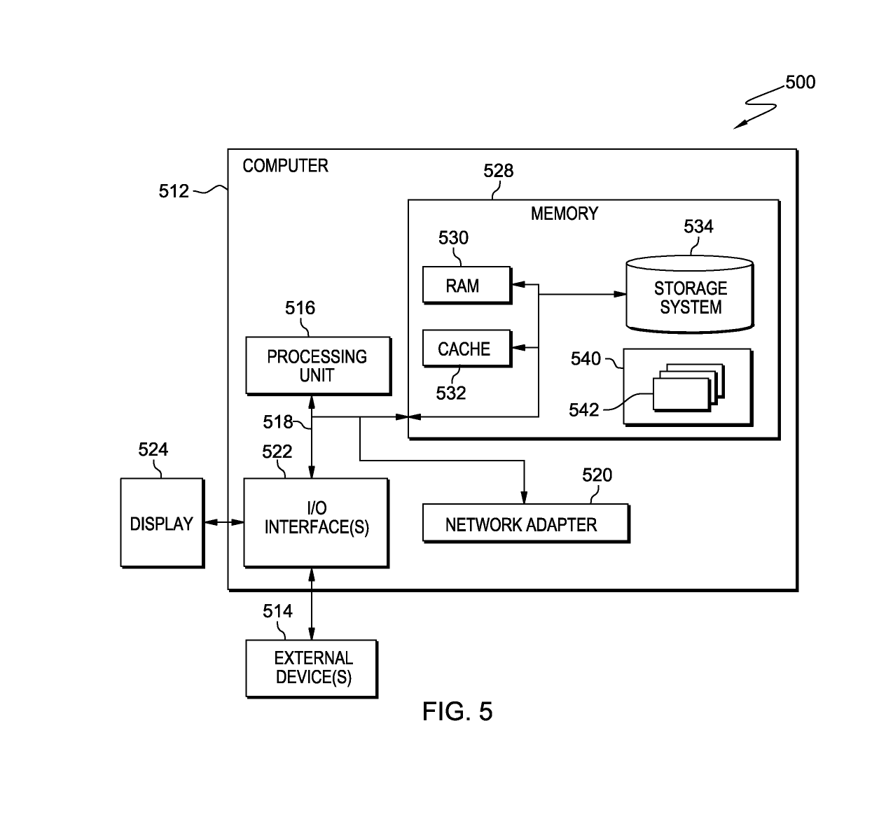

In various embodiments, each one of social media servers 104 and crowdsource servers 106, as well as recommendee system 108 and recommender system 110, can include a laptop, tablet, or netbook personal computer, a desktop computer, a personal digital assistant, a smart phone, a mainframe computer, or a networked server computer. Further, each one of social media servers 104 and crowdsource servers 106, as well as recommendee system 108 and recommender system 110, can include computing systems utilizing clustered computers and components to act as single pools of seamless resources when accessed through network 102, or can represent one or more cloud computing datacenters. In general, each one of social media servers 104 and crowdsource servers 106, as well as recommendee system 108 and recommender system 110, can be any programmable electronic device as described in further detail below with respect to FIG. 5.

Social media servers 104 include one or more social media platforms. For example, social media servers 104 can include servers hosting or providing access (e.g., through a public API, etc.) to social networks. Each social media platform provides its members with the ability to create profiles, make social media posts, and optionally to make connections with each other. Members can be people, corporations, or other entities. Members of a social media platform may be able to “friend” each other (i.e., to connect their profiles in a social graph, etc.) or to “follow” each other (i.e., to register one member as a recipient of another member's social media posts, etc.). Further, a social media platform of social media servers 104 may provide access to a member's history of past social media posts. When a member of a social media platform makes a new social media post, the new social media post is appended to the member's history, and also made public, or semi-public, depending on privacy settings stored in the member's profile. Generally, a social media post can include text or other media (e.g., a picture, etc.) on any topic. From the perspective of recommender system 110, a member that makes a social media post is the source of the social media post. As will be discussed in detail below, recommender system 110 can utilize social media posts from social media servers 104 during training interactions, as well as during recommending interactions to recommend engagement actions to be performed by recommendee system 108 on the sources of social media posts.

Crowdsource servers 106 include one or more crowdsourcing platforms. For example, crowdsource servers 106 can include servers hosting or providing access (e.g., through a public API, etc.) to crowdsourcing networks. Each crowdsourcing platform provides its requestors with the ability to obtain services, ideas, or content by soliciting contributions from a large group of people. In the context of recommender environment 100, recommender system 110 is a requestor of the crowdsourcing platforms of crowdsource servers 106. Generally, each crowdsourcing platform can be used to subdivide a requestor's work into manageable pieces, such that small contributions by individual crowdsource workers add up to a significant result. As will be discussed in detail below, recommender system 110 can utilize crowdsource workers of crowdsource servers 106 during training interactions to label social media posts from, for example, social media servers 104, as well as to enumerate words and phrases pertaining to a prompt by recommendee system 108. Recommender system 110 can use the labeled social media posts and the enumerated words and phrases for use in training one or more classifiers.

Recommendee system 108 is a system under the control of a entity that intends to directly engage members of the social media platforms of social media servers 104, i.e., to directly engage the sources of social media posts of social media servers 104. Direct engagement can be accomplished in several ways. For example, direct engagement can include sending an email to the member, making a phone call to the member, sending a private message to the member through a private messaging system of social media servers 104, or even making a responsive social media post on social media servers 104. Generally, direct engagement can be any communication responsive to a social media post of a member of social media servers 104. Each direct engagement will typically be pertinent to a specific topic, such as a brand owned or controlled by the entity, or such as the entity itself. Generally, there is no limit to the topic of a direct engagement.

The entity controlling recommendee system 108 can be a business intending to directly engage its customers for the purposes of direct marketing, viral marketing, opinion gathering, customer support, or other purposes described below. Further, the entity can be any type of entity intending to directly engage customers, prospective customers, former customers, or even non-customers. For example, the entity could be an individual, a business, a corporation, or a government intending to directly engage a member of a social media platform for any purpose. If the entity is a business, then the specific topic of the direct engagement could be, for example, the business name or a brand name of a product produced by the business. For another example, if the entity is a government, then the specific topic of the direct engagement could be the name of a member of a legislature or a title of a piece of legislation. An entity can directly engage on any topic. As will be discussed in detail below, recommendee system 108 can prompt recommender system 110 with a topic, and can receive engagement actions from recommender system 110 and use the engagement actions to directly engage the members of social media servers 104.

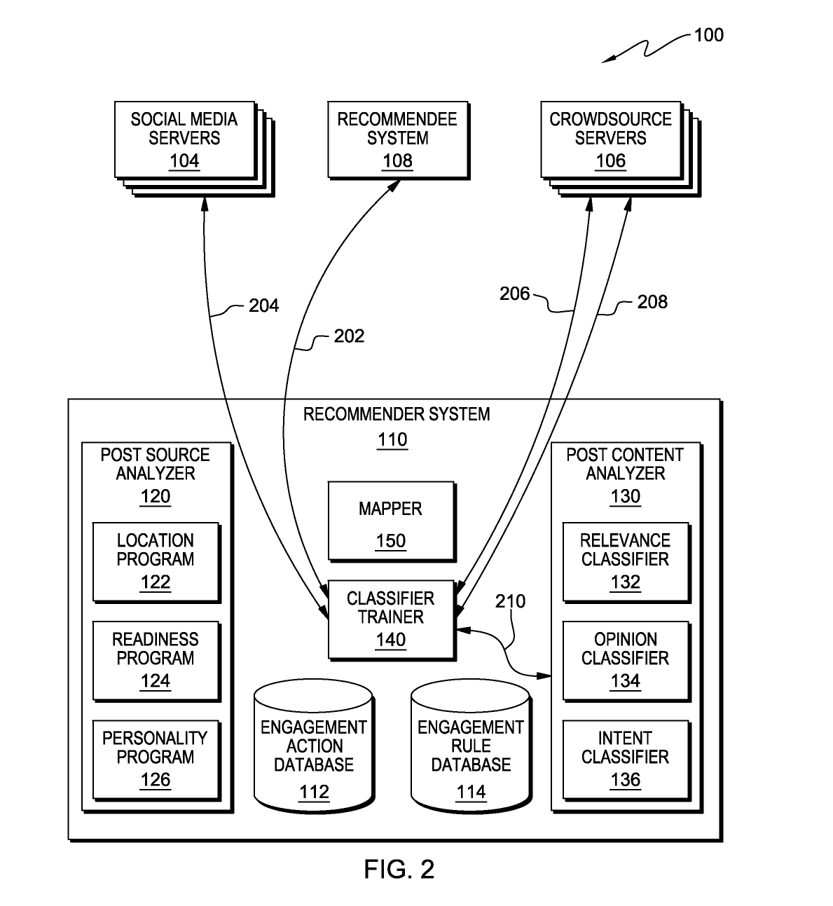

Recommender system 110 includes classifier trainer 140 and post content analyzer 130, which itself includes relevance classifier 132, opinion classifier 134, and intent classifier 136. Generally, post content analyzer 130 analyzes the content of a social media post to distinguish between relevant and not relevant social media posts; positive, neutral, and negative opinion social media posts; and posts expressing different intents; with regard to a topic received in a training interaction. Each of classifiers 132, 134, and 136 can be implemented as, for example, a support vector machine. As will be discussed in detail below in the context of FIG. 2, classifier trainer 140 trains classifiers 132, 134, and 136 of post content analyzer 130 during several training interactions.

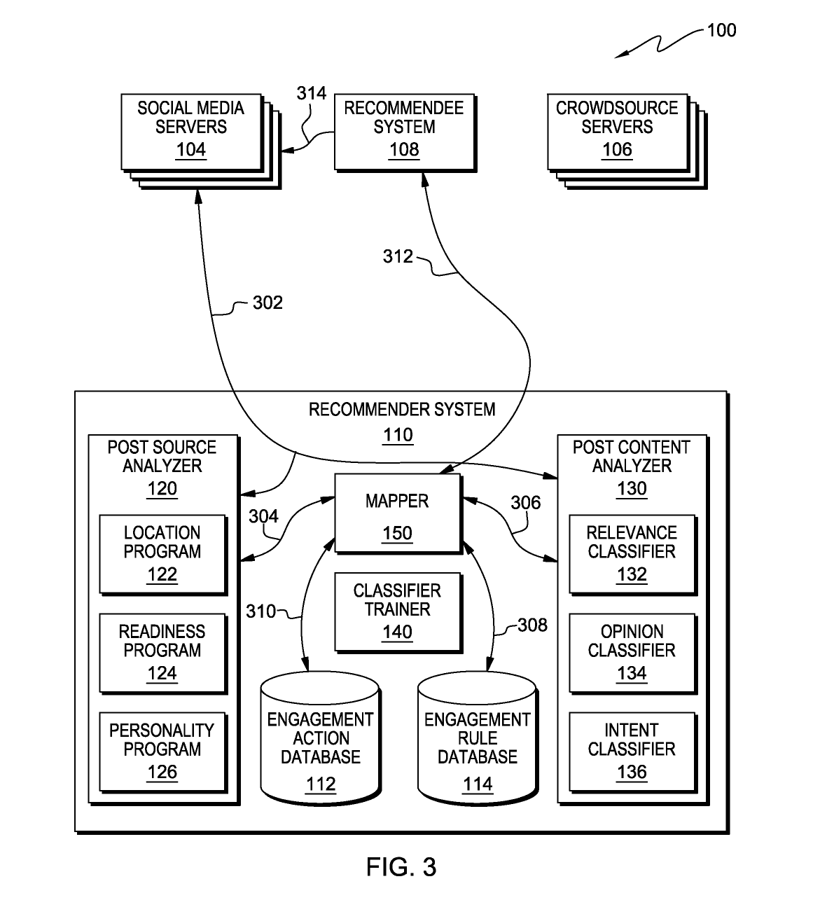

Recommender system 110 also includes mapper 150, engagement action database 112, engagement rule database 114, and post source analyzer 120, which itself includes location program 122, readiness program 124, and personality program 126. Generally, post source analyzer 120 analyzes the source of a social media post to determine his, her, or its features. In particular, location program 122 determines the location of the source based on, for example, a GPS tag embedded in the social media post, or the location of the source as reflected in a member profile on social media servers 104. Further, readiness program 124 determines whether the source of the social media post is ready to receive a direct engagement based on, for example, a presence indicator as reflected in a member profile on social media servers 104 (e.g., a presence indicator can indicate whether a human user is presently at his or her computer, or away, etc.). Further still, personality program 126 determines the personality of the source of the social media post based on, for example, a personality test applied to the source's history of past social media posts. Engagement action database 112 includes a variety of direct engagement actions, and engagement rule database 114 includes a variety of rules for mapping the direct engagement actions onto social media posts based on the output of post source analyzer 120 and post content analyzer 130. As will be discussed in detail below in the context of FIG. 3, mapper 150 uses engagement action database 112, engagement rule database 114, post source analyzer 120, and post content analyzer 130 during several recommending interactions.

Referring now to FIG. 2, a block diagram of recommender environment 100 of FIG. 1 depicting training interactions 202, 204, 206, 208, and 210 in accordance with an embodiment of the present invention is shown. Although the depiction of network 102 is omitted from FIG. 2, it should be understood that each of training interactions 202, 204, 206, 208, and 210 can entail one or more communications over network 102.

During training interaction 202, recommendee system 108 prompts classifier trainer 140 of recommender system 110 with a topic, such as a brand name of a product produced by the entity controlling recommendee system 108. In one embodiment, recommendee system 108 and recommender system 110 have no further interaction during training interactions 202, 204, 206, 208, and 210, and recommendee system 108 is not involved again until it receives an engagement action from recommender system 110 as discussed in the context of FIG. 3. Classifier trainer 140 can utilize the topic to subsequently train classifiers 132, 134, and 136 of post content analyzer 130.

During training interaction 204, classifier trainer 140 retrieves a group of training social media posts from social media servers 104. The training social media posts can number in the hundreds, thousands, or tens of thousands, for example, and can be retrieved from the history of past social media posts stored on social media servers 104. In one embodiment, the training social media posts are retrieved in a broad and shallow fashion (i.e., a few social media posts are retrieved from each history of a large number of members), while in another embodiment the training social media posts are retrieved in a narrow and deep fashion (i.e., a large number of social media posts are retrieved from the history of a few members). In yet another embodiment, the retrieval is both broad and deep. Further still, the retrieval may be temporally broad (i.e., a sampling of social media posts that were generated over a large time span) or temporally narrow (i.e., a concentration of social media posts that were generated over a short time span).

In one embodiment, the training social media posts retrieved in training interaction 204 are requested without regard to the topic received in training interaction 202. Notably, because training interactions 202, 204, 206, 208, and 210 are not yet all complete, in one embodiment classifier trainer 140 does not have a facility for determining which of the training social media posts are relevant to the topic received in training interaction 202, and which are not. As an aside, it should be further noted that determining such relevance is one of several training tasks to be accomplished, and is discussed in detail below. As such, the retrieval in training interaction 204 can be regarded as a blind or uninformed retrieval. However, in another embodiment, classifier trainer 140 has a limited facility for determining such relevance, and uses such limited facility to request training social media posts with regard to the topic received in training interaction 202.

Having completed training interactions 202 and 204, classifier trainer 140 transmits the topic received in training interaction 202, a group of crowdsource tasks to be carried out by crowdsource workers, and the training social media posts to crowdsource servers 106 in training interactions 206 and 208. In particular, in training interaction 206 classifier trainer 140 transmits the topic, three labeling crowdsource tasks, and the training social media posts to crowdsource servers 106. Further, in training interaction 208 classifier trainer 140 transmits the topic, three enumerating crowdsource tasks, and optionally the training social media posts to crowdsource servers 106. Notably, in an embodiment in which training interactions 206 and 208 are performed concurrently, communications can be combined to avoid duplicate transmission of some or all of the common information. Embodiments in which training interactions 206 and 208 are not performed concurrently are discussed below, following the discussion of the various crowdsource tasks.

The first labeling crowdsource task of training interaction 206 requests that crowdsource workers of crowdsource servers 106 label each of the training social media posts as relevant or not relevant to the topic. For example, a crowdsource worker working on a training social media post that includes verbatim text of the topic can label that post as relevant, while a crowdsource worker working on another training social media post that does not include verbatim text of the topic can label that post as not relevant. Further, a crowdsource worker working on a training social media post that includes peripheral information related to the topic can label that post as relevant according to his or her judgment. For instance, if the topic is the name of an airline company, and the training social media post is “I can't wait to get on my flight!”, then the crowdsource worker may decide to label the post as relevant. At the conclusion of the first labeling crowdsource task, all of the training social media posts have been labeled as relevant or not relevant to the topic, according to the varied judgments of a potentially large number of crowdsource workers.

The second labeling crowdsource task of training interaction 206 requests that crowdsource workers of crowdsource servers 106 label each of the training social media posts as expressing a positive, neutral, or negative opinion about the topic. For example, a crowdsource worker working on a training social media post that expresses happiness or satisfaction regarding the topic can label that post as positive, while a crowdsource worker working on another training social media post that expresses frustration or dissatisfaction regarding the topic can label that post as negative. Further, a crowdsource worker working on a training social media post that is silent on the topic, or that is not relevant, can label that post as neutral. For instance, if the topic is the name of the airline company in the preceding example, and the training social media post is “I just barely made my flight, thanks to the helpful gate attendant!”, then the crowdsource worker may decide to label the post as one expressing a positive opinion. At the conclusion of the second labeling crowdsource task, all of the training social media posts have been labeled as expressing a positive, neutral, or negative opinion about the topic, according to the varied judgments of a potentially large number of crowdsource workers.

The third labeling crowdsource task of training interaction 206 requests that crowdsource workers of crowdsource servers 106 label each of the training social media posts as indicative of a particular intent regarding the topic. For example, a crowdsource worker working on a training social media post that expresses an intent to purchase a product having the brand name of the topic can label that post as expressing purchase intent, while a crowdsource worker working on another training social media post that expresses a question about the product having the brand name of the topic can label that post as expressing questioning intent. Further, a crowdsource worker working on a training social media post that expresses no particular intent regarding the topic, or that is not relevant, can label that post as not expressing intent. For instance, if the topic is the name of a flight route sold by the airline company in the preceding example, and the training social media post is “I am looking forward to flying to New York again next month!”, then the crowdsource worker may decide to label the post as one expressing purchasing intent. At the conclusion of the third labeling crowdsource task, all of the training social media posts have been labeled as indicative of a particular intent regarding the topic, according to the varied judgments of a potentially large number of crowdsource workers.

The first enumerating crowdsource task of training interaction 208 requests that crowdsource workers of crowdsource servers 106 enumerate words and phrases relevant to the topic. For example, if the topic is the name of the airline company in the preceding example, a crowdsource worker might enumerate “airplane,” “airline,” “flying,” “baggage carousel,” “wings,” and “pilot.” In one embodiment, the first enumerating crowdsource task is assigned and performed independently of the three labeling crowdsource tasks of training interaction 206, such that the crowdsource worker performing the first enumerating crowdsource task is not aware of the training social media posts or their labels. In another embodiment, the first enumerating crowdsource task is assigned and performed in coordination with one or more of the three labeling crowdsource tasks, such that the crowdsource worker performing the first enumerating crowdsource task can be primed for enumeration based on the context of the training social media posts, their labels, or both. At the conclusion of the first enumerating crowdsource task, words and phrases relevant to the topic have been enumerated by a potentially large number of crowdsource workers.

The second enumerating crowdsource task of training interaction 208 requests that crowdsource workers of crowdsource servers 106 enumerate words and phrases expressing a positive, neutral, or negative opinion about the topic. For example, if the topic is the name of the airline company in the preceding example, a crowdsource worker might enumerate “no delays,” “long delays,” “friendly attendants,” “easy check-in,” “lost baggage,” and “clean terminal.” In one embodiment, the second enumerating crowdsource task is assigned and performed independently of the three labeling crowdsource tasks of training interaction 206, such that the crowdsource worker performing the second enumerating crowdsource task is not aware of the training social media posts or their labels. In another embodiment, the second enumerating crowdsource task is assigned and performed in coordination with one or more of the three labeling crowdsource tasks, such that the crowdsource worker performing the second enumerating crowdsource task can be primed for enumeration based on the context of the training social media posts, their labels, or both. At the conclusion of the second enumerating crowdsource task words and phrases expressing a positive, neutral, or negative opinion about the topic have been enumerated by a potentially large number of crowdsource workers.

The third enumerating crowdsource task of training interaction 208 requests that crowdsource workers of crowdsource servers 106 enumerate words and phrases indicative of a particular intent regarding the topic. For example, if the topic is the name of the airline company in the preceding example, a crowdsource worker might enumerate “looking forward to flying,” “why not enough attendants,” “where's the airport,” “need to ask the gate agent,” “use terminal parking,” and “check my flight status.” In one embodiment, the third enumerating crowdsource task is assigned and performed independently of the three labeling crowdsource tasks of training interaction 206, such that the crowdsource worker performing the third enumerating crowdsource task is not aware of the training social media posts or their labels. In another embodiment, the third enumerating crowdsource task is assigned and performed in coordination with one or more of the three labeling crowdsource tasks, such that the crowdsource worker performing the third enumerating crowdsource task can be primed for enumeration based on the context of the training social media posts, their labels, or both. At the conclusion of the third enumerating crowdsource task, words and phrases indicative of a particular intent regarding the topic have been enumerated by a potentially large number of crowdsource workers.

Having described the group of crowdsource tasks to be carried out by crowdsource workers during training interactions 206 and 208, it should be repeated that in one embodiment, training interactions 206 and 208 occur concurrently, such that classifier trainer 140 transmits the topic received in training interaction 202, the group of labeling and enumerating crowdsource tasks, and the training social media posts to crowdsource servers 106 concurrently. However, in another embodiment, after receiving the topic in training interaction 202, classifier trainer 140 can instead perform training interactions 204 and 208 concurrently, and then initiate training interaction 206 at the conclusion of training interaction 204. This is the case because training interaction 208 does not necessarily require the training social media posts received during training interaction 204, but training interaction 206 does require them. In particular, the three enumerating crowdsource tasks can be performed with or without regard to the training social media posts, but the three labeling crowdsource tasks must be performed with regard to the training social media posts. At the conclusion of each of training interactions 206 and 208, crowdsource servers 106 transmits the resulting labeled training social media posts or enumerated words and phrases to classifier trainer 140.

Having completed training interactions 206 and 208, classifier trainer 140 has received labeled training social media posts and enumerated words and phrases from crowdsource servers 106. During training interaction 210, classifier trainer 140 uses the labeled training social media posts as ground truth data, and uses the enumerated words and phrases as prospective rules, to train classifiers 132, 134, and 136 of post content analyzer 130. In particular, classifier trainer 140 uses the labeled training social media posts and the enumerated words and phrases from the first enumerating crowdsource task (i.e., the “relevance enumeration” task) to train relevance classifier 132, uses the labeled training social media posts and the enumerated words and phrases from the second enumerating crowdsource task (i.e., the “opinion enumeration” task) to train opinion classifier 134, and uses the labeled training social media posts and the enumerated words and phrases from the third enumerating crowdsource task (i.e., the “intent enumeration” task) to train intent classifier 136.

The labeled training social media posts are referred to as ground truth data because their labels have been selected and applied by crowdsource workers, independently of the operation of classifiers 132, 134, and 136. The enumerated words and phrases are referred to as prospective rules, rather than established rules, because the efficacy of each word or phrase as a rule is not established until the training of classifiers 132, 134, and 136 is complete. In other words, training interaction 210 will reveal the efficacy of each enumerated word or phrase as a rule for judging the relevance, opinion, or intent of a social media post with regard to the topic received in training interaction 202.

Each of classifiers 132, 134, and 136 can be implemented as a support vector machine in one embodiment, but in other embodiments can be implemented as another classifier, such as a binary classifier, a linear classifier, or a nonlinear classifier, for example. A support vector machine is typically trained with training data prior to being deployed for use on production data. Each datum in the training data includes a target label and a collection of observed data connected to the target label. The goal of using the support vector machine technique is to produce a model, based on the training data, which predicts, using rules, the target labels of the production data. During training, the support vector machine maps the training data into a higher dimensional space, and finds a separating hyperplane or other separator with the maximal margin in the higher dimensional space. Support vector machines can utilize different kernels, which are functions that affect the mapping. For example, kernels can include a linear kernel, a polynomial kernel, a radial basis function kernel, and a chi squared kernel.

Accordingly, each of classifiers 132, 134, and 136 is trained prior to use with the labeled training social media posts, which each include a target label (i.e., a label applied during the three labeling crowdsource tasks of training interaction 206) and a collection of observed data connected to the target label (i.e., the actual content of the labeled training social media post). A score generation component of classifier trainer 140 scores each of the labeled training social media posts according to whether or not its actual content includes a word or phrase that matches the enumerated words and phrases of the pertinent classifier. For example, during the training of relevance classifier 132, each of the labeled training social media posts is scored according to whether or not its actual content includes a word or phrase that matches the enumerated words and phrases of the first enumerating crowdsource task (i.e., the “relevance enumeration” task). In the same vein, during the training of opinion classifier 134 and intent classifier 136, scoring is performed according to matches of the enumerated words and phrases of the second and third enumerating crowdsource tasks, respectively.

During training, each of classifiers 132, 134, and 136 learns from the labels and enumerations how to distinguish between relevant and not relevant social media posts; positive, neutral, and negative opinion social media posts; and posts expressing different intents; with regard to the topic received in training interaction 202. In particular, during training each of classifiers 132, 134, and 136 constructs a hyperplane or a set of hyperplanes that achieves a good separation between sets of scores, generated from the prospective rules applied to each labeled training social media post, associated with each labeled training social media post. Further, during training, the enumerated words and phrases that have high efficacy in distinguishing social media posts can be retained in their respective trained classifier (i.e., can be regarded as established rules), and those having low efficacy can be removed, to increase the efficiency of their respective trained classifier. After training, each of classifiers 132, 134, and 136 has been trained to classify social media posts during recommending interactions, as discussed in the context of FIG. 3.

In one embodiment, each of classifiers 132, 134, and 136 is implemented with an open library for support vector machines, such as LIBSVM. In particular, in one embodiment, each of classifiers 132, 134, and 136 can be implemented by use of the techniques discussed in Chih-Chung Chang and Chih-Jen Lin, “LIBSVM: a library for support vector machines,” ACM Transactions on Intelligent Systems and Technology, 2:27:1-27:27, 2011, which is herein incorporated by reference in its entirety.

Referring now to FIG. 3, a block diagram of recommender environment 100 of FIG. 1 depicting recommending interactions 302, 304, 306, 308, 310, 312, and 314 in accordance with an embodiment of the present invention is shown. Although the depiction of network 102 is omitted from FIG. 3, it should be understood that each of recommending interactions 302, 304, 306, 308, 310, 312, and 314 can entail one or more communications over network 102.

During recommending interaction 302, a social media post is retrieved from social media servers 104 by recommender system 110. Recommender system 110 routes the social media post to both of post source analyzer 120 and post content analyzer 130. Post source analyzer 120 utilizes location program 122, readiness program 124, and personality program 126 to determine the location, readiness for direct engagement, and personality of the source of the social media post, and transmits this information to mapper 150 in recommending interaction 304. Post content analyzer 130 uses relevance classifier 132, opinion classifier 134, and intent classifier 136 to determine whether the social media post is relevant or not relevant; has a positive, neutral, or negative opinion; and expresses a particular intent; with regard to the topic received in training interaction 202, and transmits this information to mapper 150 in recommending interaction 306.

Mapper 150 uses the information received in recommending interactions 304 and 306 to pull a matching rule from engagement rule database 114. Each rule maps a particular combination of results from post source analyzer 120 and post content analyzer 130 onto a direct engagement stored in engagement action database 112. Each rule, and each direct engagement, can be determined by an expert according to the needs of the entity, controlling recommendee system 108, that intends to directly engage members of the social media platforms of social media servers 104. Example direct engagements include sending a coupon, establishing a customer support ticket, making an apology, answering a question, or expressing appreciation, for example. An example rule includes sending a coupon for a particular product if the source of a social media post is within 10 miles of a retail outlet of the entity, is ready for a direct engagement, regardless of personality, and if the content of the social media post is relevant to the particular product, is indicative of a positive or neutral opinion about the particular product, and is indicative of an intent to make a purchase. Another example rule includes making an apology if the source of a social media post, is ready for a direct engagement, has a forgiving personality, regardless of location, and if the content of the social media post is relevant to the entity, is indicative of a negative opinion about the entity, and is indicative of an intent to make further negative social media posts. Of course, there is no limitation to the kind of rules and direct engagements that can be stored in recommender system 110 and applied in a recommending interaction.

In an alternate embodiment, mapper 150 can include a classifier, similar to classifiers 132, 134, and 136, that has been trained to map a particular combination of results from post source analyzer 120 and post content analyzer 130 onto a direct engagement stored in engagement action database 112. In such an alternate embodiment, engagement rule database 114 is omitted, because the rules are effectively internal to the classifier of the alternate mapper 150. Such a classifier can be trained based on historical direct engagement data.

Accordingly, during recommending interaction 308 mapper 150 pulls a matching rule from engagement rule database 114, and during recommending interaction 310 mapper 150 pulls the direct engagement of the matching rule from engagement action database 112. During recommending interaction 312, mapper 150 transmits an instruction regarding the direct engagement to recommendee system 108. For example, the instruction can include the direct engagement to be performed, as well as the source of the social media post, retrieved in recommending interaction 302, that recommendee system 108 should perform the direct engagement on. In recommending interaction 314, recommendee system 108 performs the direct engagement on the source of the social media post by contacting the source via social media servers 104. Of course, in various embodiments, recommending interaction 314 can be performed by contacting the source via a different channel (e.g., email, phone, etc.). Further, in another embodiment, recommender system 110 can perform the direct engagement itself, on behalf of the entity controlling recommendee system 108.

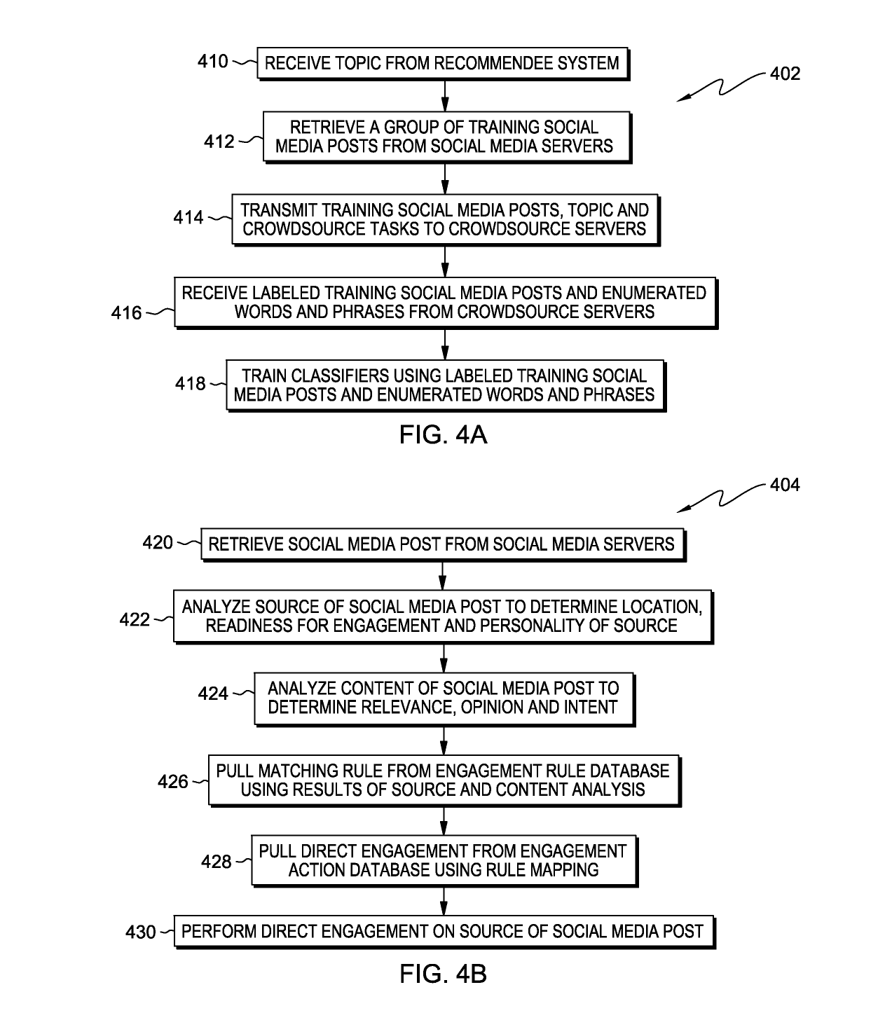

FIGS. 4A and 4B are flowcharts depicting steps followed by recommender system 110 of recommender environment 100 of FIG. 1 during training interactions and recommending interactions in accordance with an embodiment of the present invention.

Referring now to FIG. 4A, flowchart 402 depicts steps followed by recommender system 110 during training interactions 202, 204, 206, 208, and 210. In step 410, recommender system 110 receives a topic from recommendee system 108 (training interaction 202). In step 412, recommender system 110 retrieves a group of training social media posts from social media servers 104 (training interaction 204). In step 414, recommender system 110 transmits the training social media posts, topic, and crowdsource tasks to crowdsource servers 106 (transmission portion of training interactions 206 and 208). In step 416, recommender system 110 receives labeled training social media posts and enumerated words and phrases from crowdsource servers 106 (reception portion of training interactions 206 and 208). In step 418, recommender system 110 trains the classifiers of post content analyzer 130 using the labeled training social media posts and enumerated words and phrases (training interaction 210).

Referring now to FIG. 4B, flowchart 404 depicts steps followed by recommender system 110 during recommending interactions 302, 304, 306, 308, 310, 312, and 314. In step 420, recommender system 110 retrieves a social media post from social media servers 104 (recommending interaction 302). In step 422, recommender system 110 analyzes the source of the social media post to determine his, her, or its location, readiness for engagement, and personality, using post source analyzer 120 (recommending interaction 304). In step 424, recommender system 110 analyzes the content of the social media post to determine its relevance, opinion, and intent, using post content analyzer 130 (recommending interaction 306). In step 426, recommender system 110 pulls a matching rule from engagement rule database 114 using the results of the source and content analysis, using mapper 150 (recommending interaction 308). In step 428, recommender system 110 pulls a direct engagement from engagement action database 112 using rule mapping, using mapper 150 (recommending interaction 310). In step 430, recommender system 110 (in one embodiment, via recommendee system 108) performs a direct engagement on the source of the social media post (recommending interactions 312 and 314).

Referring now to FIG. 5, a block diagram of a computer system in accordance with an embodiment of the present invention is shown. Computer system 500 is only one example of a suitable computer system and is not intended to suggest any limitation as to the scope of use or functionality of embodiments of the invention described herein. Regardless, computer system 500 is capable of being implemented and/or performing any of the functionality set forth hereinabove.

In computer system 500 there is computer 512, which is operational with numerous other general purpose or special purpose computing system environments or configurations. Examples of well-known computing systems, environments, and/or configurations that may be suitable for use with computer 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of social media servers 104 and crowdsource servers 106, as well as recommendee system 108 and recommender system 110, can include or can be implemented as an instance of computer 512.

Computer 512 may be described in the general context of computer system executable instructions, such as program modules, being executed by a computer system. Generally, program modules may include routines, programs, objects, components, logic, data structures, and so on that perform particular tasks or implement particular abstract data types. Computer 512 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 5, computer 512 in computer system 500 is shown in the form of a general-purpose computing device. The components of computer 512 may include, but are not limited to, one or more processors or processing units 516, memory 528, and bus 518 that couples various system components including memory 528 to processing unit 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 512 typically includes a variety of computer system readable media. Such media may be any available media that is accessible by computer 512, and includes both volatile and non-volatile media, and removable and non-removable media. One or both of engagement action database 112 and engagement rule database 114 can be stored on such media.

Memory 528 can include computer system readable media in the form of volatile memory, such as random access memory (RAM) 530 and/or cache 532. Computer 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program 540, having one or more program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. Post source analyzer 120, post content analyzer 130, classifier trainer 140, and mapper 150 can be implemented as or can be an instance of program 540.

Computer 512 may also communicate with one or more external devices 514 such as a keyboard, a pointing device, or one or more devices that enable a user to interact with computer 512, such as via display 524; and/or any devices (e.g., network card, modem, etc.) that enable computer 512 to communicate with one or more other computing devices. Such communication can occur via Input/Output (I/O) interfaces 522. Still yet, computer 512 can communicate with one or more networks such as a local area network (LAN), a general wide area network (WAN), and/or a public network (e.g., the Internet) via network adapter 520. As depicted, network adapter 520 communicates with the other components of computer 512 via bus 518. It should be understood that although not shown, other hardware and/or software components could be used in conjunction with computer 512. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor (i.e., a computing processor) of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

What is claimed is:

1. A method for recommending a direct engagement pertinent to a topic to be performed on a source of a social media post, comprising:
receiving a social media post from a social media server;
determining a first information about the source of the social media post;
determining, using at least one classifier, a second information about the content of the social media post, wherein the at least one classifier has been trained based at least in part on a topic;
mapping the first information and the second information onto a direct engagement pertinent to the topic, based on a rule; and
recommending the direct engagement to be performed on the source of the social media post.

2. The method of claim 1, further comprising receiving a plurality of labeled training social media posts from a crowdsource server.

3. The method of claim 2, further comprising training the at least one classifier to perform at least a portion of the determining the second information, wherein the training is based at least in part on the plurality of labeled training social media posts.

4. The method of claim 1, further comprising receiving a plurality of enumerated words and phrases from a crowdsource server.

5. The method of claim 4, further comprising training the at least one classifier to perform at least a portion of the determining the second information, wherein the training is based at least in part on the plurality of enumerated words and phrases.

6. The method of claim 1, wherein the determining the first information includes determining the location of the source of the social media post, the readiness for engagement of the source of the social media post, or the personality of the source of the social media post.

7. The method of claim 1, wherein the determining the second information includes determining the relevance of the content of the social media post to the topic, the opinion of the content of the social media post about the topic, or the intent of the content of the social media post regarding the topic.

8. The method of claim 1, further comprising receiving the topic from a recommendee system.

9. The method of claim 8, wherein the direct engagement is recommended to the recommendee system.

10. The method of claim 9, wherein the rule and the direct engagement have each been determined according to the needs of an entity controlling the recommendee system.

11. A computer program product for recommending a direct engagement pertinent to a topic to be performed on a source of a social media post, comprising a computer readable storage medium having program code embodied therewith, the program code executable by a processor to:
receive a social media post from a social media server;
determine a first information about the source of the social media post;
determine, using at least one classifier, a second information about the content of the social media post, wherein the at least one classifier has been trained based at least in part on a topic;
map the first information and the second information onto a direct engagement pertinent to the topic, based on a rule; and
recommend the direct engagement to be performed on the source of the social media post.

12. The computer program product of claim 11, further comprising program code to receive a plurality of labeled training social media posts from a crowdsource server.

13. The computer program product of claim 12, further comprising program code to train the at least one classifier to perform at least a portion of determining the second information, wherein the training is based at least in part on the plurality of labeled training social media posts.

14. The computer program product of claim 11, further comprising program code to receive a plurality of enumerated words and phrases from a crowdsource server.

15. The computer program product of claim 14, further comprising program code to train the at least one classifier to perform at least a portion of determining the second information, wherein the training is based at least in part on the plurality of enumerated words and phrases.

16. The computer program product of claim 11, wherein determining the first information includes determining the location of the source of the social media post, the readiness for engagement of the source of the social media post, or the personality of the source of the social media post.

17. The computer program product of claim 11, wherein determining the second information includes determining the relevance of the content of the social media post to the topic, the opinion of the content of the social media post about the topic, or the intent of the content of the social media post regarding the topic.

18. The computer program product of claim 11, further comprising program code to receive the topic from a recommendee system.

19. The computer program product of claim 18, wherein the direct engagement is recommended to the recommendee system.

20. A system for recommending a direct engagement pertinent to a topic to be performed on a source of a social media post, comprising:
a network interface configured to receive a social media post from a social media server;
a post source analyzer configured to determine a first information about the source of the social media post;
a post content analyzer configured to determine, using at least one classifier, a second information about the content of the social media post, wherein the at least one classifier has been trained based at least in part on a topic; and
a mapper configured to map the first information and the second information onto a direct engagement pertinent to the topic, based on a rule;
wherein the system is configured to recommend the direct engagement to be performed on the source of the social media post.
